(19) United States
(12) Patent Application Publication
(10) Pub. No.: US 2025/0342102 A1
(43) Pub. Date: Nov. 6, 2025

(54) MACHINE LEARNING MODEL-BASED SIMULATION OF PROCESSOR UTILIZATION

(71) Applicant: INTERNATIONAL BUSINESS MACHINES CORPORATION, Armonk, NY (US)

(72) Inventors: Kelley ANDERS, East New Market, MD (US); Yihua LI, San Jose, CA (US); Andrew T PENROSE, Dublin (IE); Jonathan D DUNNE, Dublin (IE)

(21) Appl. No.: 18/655,412

(22) Filed: May 6, 2024

(51) Int. Cl. G06F 11/34; G06F 11/36

(52) U.S. Cl. CPC G06F 11/3457; G06F 11/3604

(57) ABSTRACT

A machine learning-based processor utilization prediction process is provided which includes training a processor utilization model using system log data, code feature data, and processor-associated data of a system to, at least in part, predict processor utilization to execute application code on the system. In addition, the process includes generating, using the processor utilization model, a processor utilization simulation for the system to execute the application code, and initiating an action based on the processor utilization simulation for the system to execute the application code.

### BACKGROUND

This disclosure relates generally to the field of computing, and more particularly, to facilitating processing within a computing environment, including by simulating processor utilization for a system to execute application code.

Sustainability is a rapidly growing area of focus, including in computing environments, such as data center environments and cloud-based computing environments. With the continued increase in computing usage, there is an ever increasing demand for data centers globally. Power consumption of data centers is related to the number and type of servers within the data center. In today's data centers, the main system architectures use complex instruction set computer (CISC)-based processors and/or reduced instruction set computer (RISC)-based processors. Distinguishing characteristics between CISC-based processors and RISC-based processors include that RISC-based processors use a smaller number of computer instruction types than the CISC-based processors, and RISC-based processors generally run at a lower power cycle than CISC-based processors.

### SUMMARY

Certain shortcomings of the prior art are overcome, and additional advantages are provided herein through the provision of a computer-implemented method of facilitating processing within a computing environment. The computer-implemented method includes training a processor utilization model using system log data, code feature data, and processor-associated data of a system to, at least in part, predict processor utilization to execute application code on the system, where the processor utilization model is a machine learning processor utilization model. In addition, the computer-implemented method includes generating, using the processor utilization model, a processor utilization simulation for the system to execute the application code, and initiating an action based on the processor utilization simulation for the system to execute the application code.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of present disclosure;

FIGS. 2A-2B depict one embodiment of a computer program product with a processor utilization simulation module, in accordance with one or more aspects of present disclosure;

FIGS. 3A-3B depict one embodiment of a processor utilization simulation process, in accordance with one or more aspects of present disclosure;

FIG. 4 is a further example of a computing environment to include and/or use one or more aspects of present disclosure;

FIGS. 5A-5B depict a further embodiment of a processor utilization simulation process, in accordance with one or more aspects of the present disclosure;

FIGS. 6A-6B graphically illustrate processor utilization in executing code for related work on a CISC-based system and a RISC-based system, in accordance with one or more aspects of the present disclosure;

FIG. 7 depicts another example of a processor utilization simulation workflow, in accordance with one or more aspects of the present disclosure;

FIG. 8 depicts details of one embodiment of training a processor utilization model, in accordance with one or more aspects of the present disclosure; and

FIG. 9 illustrates further details of one embodiment of training a processor utilization model, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known systems, devices, processing techniques, tools, models, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, models, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

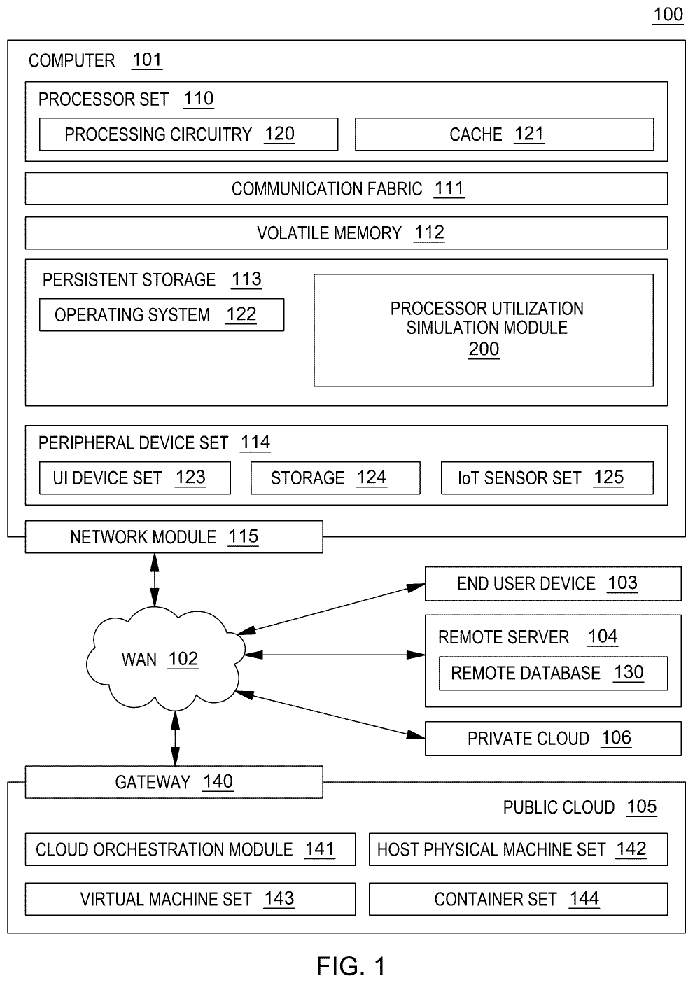

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and processor utilization simulation module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform intelligent workflow processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as processor utilization simulation module 200. In addition to processor utilization simulation module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and processor utilization simulation module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 200 in persistent storage 113.

Communication fabric 111 is the signal conduction path that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in module 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

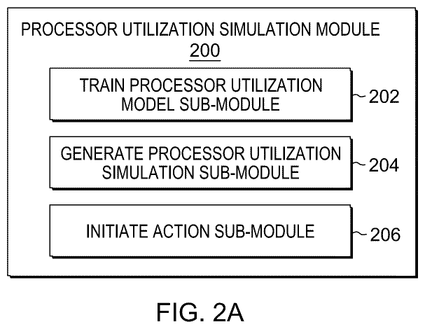

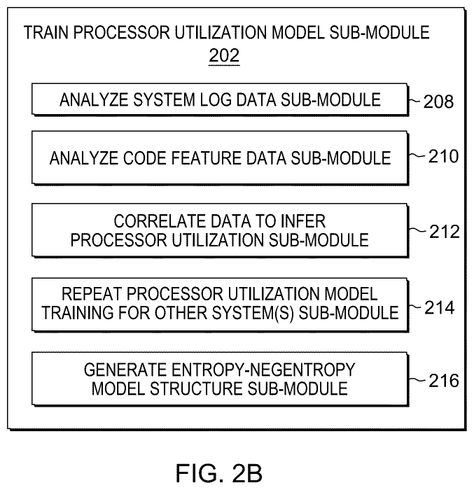

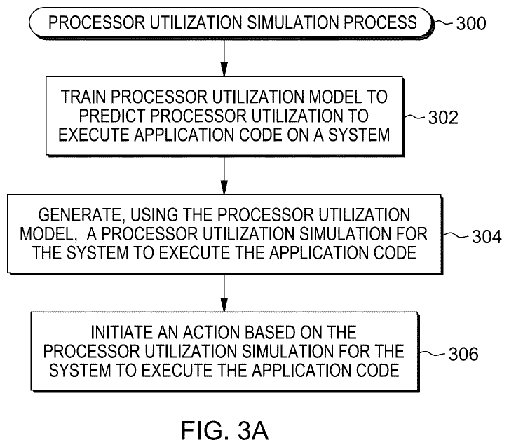

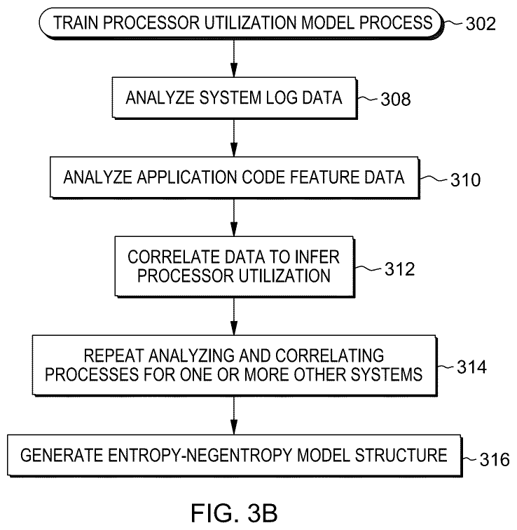

By way of example, one or more embodiments of a processor utilization simulation module and process are described initially with reference to FIGS. 2A-3B. FIGS. 2A-2B depict one embodiment of processor utilization simulation module 200 that includes code or instructions to perform processor utilization simulation processing, in accordance with one or more aspects of the present disclosure, and FIGS. 3A-3B depict one embodiment of a processor utilization simulation process, in accordance with one or more aspects of the present disclosure.

Referring to FIGS. 1-2B, processor utilization simulation module 200 includes, in one example, various sub-modules used to perform processing, in accordance with one or more aspects of the present disclosure. The sub-modules are, e.g., computer-readable program code (e.g., instructions) and computer-readable media (e.g., persistent storge (e.g., persistent storage 113, such as a disk) and/or a cache (e.g., cache 121), as examples). The computer-readable media can be part of a computer program product and can be executed by and/or using one or more computers, such as computer(s) 101; one or more processor sets 110 (FIG. 1); processors, such as one or more processors of processor set 110; and/or processing circuitry, such as processing circuitry of processor set 110, etc.

As noted, FIGS. 2A-2B depict one embodiment of a processor utilization simulation module 200 which, in one or more embodiments, includes, or facilitates, processor utilization simulation processing in accordance with one or more aspects of the present disclosure. In the embodiment of FIGS. 2A-2B, example sub-modules of processor utilization simulation module 200 include a train processor utilization sub-module 202 to, at least in part, train a machine learning processor utilization model to predict processor utilization to execute application code on a system. In addition, processor utilization simulation module 200 includes a generate processor utilization simulation sub-module 204 to generate, using the processor utilization model, a processor utilization simulation for the system to execute the application code. In one or embodiments, processor utilization simulation module 200 further includes an initiate action sub-module 206 to initiate an action based on the processor utilization simulation for the system to execute the application code. For instance, in one embodiment, the action can be one or more actions to reduce processor usage, power usage, and/or costs associated with executing the application code on the system. For instance, in one or more embodiments, initiating the action can include initiating a change in one or more code features based on the processor utilization simulation. In one or more other embodiments, initiating the action can include scheduling an execution time or rescheduling an execution time to, for instance, take advantage of lower cost power during certain periods of the day for an application code with anticipated higher processor utilization based on the processor utilization simulation. In one or more other embodiments, initiating the action can include initiating replacement of one or more servers based on system processor type (or central processor unit (CPU) type) to, for instance, facilitate executing application code on one processor type system versus another processor type system. In addition, initiating an action can include, in one or more embodiments, generating one or more graphical representations of time series predictions of the processor utilization simulation to facilitate, for instance, comparison of a predicted processor utilization of the system with an actual or predicted processor utilization of another system, such as where the system and the other system are based on different processor architectures, such as a reduced instruction set computer (RISC)-based system and a complex instruction set computer (CISC)-based system.

As illustrated in FIG. 2B, train processor utilization model sub-module 202 includes, in one or more embodiments, an analyze system log data sub-module 208 to analyze and investigate system data sets, and an analyze code feature data sub-module 210 to, for instance, analyze code feature data, such as executing source code components (e.g., compartments or blocks) using a static code analyzer to determine code content. In addition, in one or more embodiments, train processor utilization model sub-module 202 includes a correlate data to infer processor utilization sub-module 212 to, for instance, correlate telemetry data with the system log data and the executed code resulting in the system log data. In one or more embodiments, train processor utilization model sub-module 202 further includes a repeat processor utilization model training for other system(s) sub-module 214 to, for instance, repeat the analyzing processes and the correlation process for the other system's log data as well as the other system's code feature data to correlate the telemetry data of the other system with that system's log data and executing code (e.g., executing source code). In one or more embodiments, train processor utilization model sub-module 202 further includes a generate entropy-negentropy model structure sub-module 216 to build the processor utilization model structure based on the analyzed log event data and the analyzed source code features data to facilitate correlation of different processor architectures of different systems and related or comparable code running on, or to run on, the systems, as well as to obtain an offset position between the correlations. Note in this regard that, as used herein, application code refers to one or more application code programs or source code programs to run on a particular system, and related code or comparable code refers to one or more related application code programs or related source code programs to run on another system, where the system and the other system have different processor architectures, and their respective program code is configured to execute on the respective system while accomplishing similar, or at least in part, the same work on the different systems. In this manner, a comparison can be made between running one or more source code programs on a system including one processor type architecture versus running comparable code on another system having a different processor type architecture, with the RISC-based architecture and CISC-based architecture being discussed herein, by way of example only.

Advantageously, in one or more aspects, improved processing within a computing environment is provided by, for instance, providing a processor utilization simulation module and process, which train a machine learning processor utilization model and use the model to generate one or more processor utilization simulations, based on which one or more actions are initiated. In one or more embodiments, the processor utilization model is used to generate the processor utilization simulation for the system from an offset position of processor utilization time series data for another system, which can be actual time series data or predicted time series data. For instance, in one embodiment, a graphical representation can be generated of a processor utilization simulation for a system of one processor type based on time series data of processor utilization in another system of different processor type, where the time series data of processor utilization in the other system can be actual time series data or predicted time series data. In one or more embodiments, the processor utilization simulation can be combined with a power cost function to predict cost of executing an application code on the system and/or to determine power cost in executing the application on the other system. In one or more embodiments, the processor utilization model can be generalized across application code languages (e.g., source code languages), as well as different application code, service types, as well as different processor architecture based systems, such as between a RISC-based system, a CISC-based system and/or a CISC/RISC-based hybrid system. Further, by combining time series data and simulation techniques, the processor utilization simulation module process disclosed herein provides a lightweight approach to simulating, for instance, RISC-based processor utilization patterns from CISC-based processor data alone. Additionally, the processor utilization simulation module and process can be extended using feature selection to determine dependent processes (e.g., using static code analysis) on processor utilization that can apply beyond the scope of RISC-based architectures and CISC-based architectures alone.

Note that although various sub-modules are described herein, processor utilization simulation module processing, such as disclosed, can use, or include, additional, fewer, and/or different sub-modules. A particular sub-module can include additional code, including code of other sub-modules, or less code. Further, additional and/or fewer sub-modules can be used. Many variations are possible.

In one or more embodiments, the processor utilization simulation module is used, in accordance with one or more aspects of the present disclosure, to perform processor utilization simulation-related processing. FIGS. 3A-3B depict one example of a processor utilization simulation process 300, such as disclosed herein. The process is executed, in one or more embodiments, by a computer (e.g., computer 101 (FIG. 1)), and/or one or more processor sets, such as a processor or processing circuitry (e.g., of processor set 110 of FIG. 1). In one example, code or instructions implementing the process, are part of a module, such as processor utilization simulation module 200. In other examples, the code can be included in one or more other modules and/or one or more other sub-modules of the one or more other modules. Various options are available.

As illustrated in FIG. 3A, in one example, processor utilization simulation process 300 executing on one or more computers (e.g., computer 101 of FIG. 1), one or more processor sets (e.g., processor set 110 of FIG. 1, such as a processor of processing circuitry of the processor set) trains a machine learning utilization model to predict processor utilization to execute application code on a system 302. As illustrated in FIG. 3B, training the processor utilization model process 302 includes, in one or more embodiments, analyzing existing system log data 308, such as by using exploratory data analysis, and analyzing code feature data 310, such as code blocks or source code compartments or components of one or more application codes. Analyzing code feature data 310 can be implemented, for instance, using a static code analyzer to determine the code content. In one or more embodiments, training processor utilization model process 302 further includes correlating the analyzed data to infer processor utilization 312. For instance, system processor telemetry data can be correlated with the system log data and executed source code. In one or more embodiments, training processor utilization model process 302 further includes repeating the analyzing and the correlating process for one or more other systems 314, such as one or more other processor-type based systems. Based on the correlated data to infer processor utilization for the different systems, an entropy-negentropy model structure is generated 316 to correlate processor utilization differences between different systems and to establish an offset position between the correlations to allow, for instance, generating a processor utilization simulation for one system from time series data for the other system and the offset position, using the processor utilization model. By way of example, an initial offset position can be determined by prior data analysis of the different system processor utilization data. Based on analysis of multiple datasets, a probability density distribution of distances between utilization data values can be fit. A mean of the fitted distribution distance values can then be used as an initial starting point for the offset value.

As illustrated in FIG. 3A, processor utilization simulation process 300 further includes (in one or more embodiments) generating, using the processor utilization model, a processor utilization simulation for the system to execute the application code 304. In one or more embodiments, generating the simulation can be from the offset position using, for instance, a Poisson Hidden Markov model. However, other approaches to generating the processor utilization simulation can also be employed. In one or more embodiments, processor utilization simulation 300 further includes initiating an action based on the processor utilization simulation for the system to execute the application code 306. As noted, in one or more embodiments, the action can be one or more actions to reduce or remediate processor usage, power usage, and/or cost associated with executing the code on the system. For instance, in one or more embodiments, initiating the action can include initiating a change in one or more code features based on the processor utilization simulation to reduce processor utilization. In one or more other embodiments, initiating the action can include scheduling an execution time or rescheduling an execution time to, for instance, take advantage of lower cost power during certain periods for an application code with predicted higher processor utilization based on the processor utilization simulation. In one or more other embodiments, initiating the action can include initiating replacement of one or more servers based on processor type system (e.g. CPU type) to, for instance, facilitate executing application code on one processor type system versus another system processor type. In addition, initiating an action can include, in one or more embodiments, generating one or more graphical representations of time series predictions of the processor utilization simulation to facilitate, for instance, comparison of a predicted processor utilization of the system with an actual or predicted processor utilization of another system, such as where the system and the other system are based on different processor architectures, such as a reduced instruction set computer (RISC)-based system and a complex instruction set computer (CISC)-based system.

In one or more aspects, the processes, computer program products and computing systems disclosed use artificial intelligence (e.g., execute an artificial intelligence agent) to provide the trained machine learning model for use in simulating processor utilization of the system. In one or more embodiments, artificial intelligence includes machine learning, which can further include deep learning comprised of one or more neural networks. In one aspect, artificial intelligence can take raw data and learn to generate statistically probable outputs. Artificial intelligence enables a computing system or device (e.g., at least one artificial intelligence agent executing on the computing system) to obtain and/or derive information, learn from that information, and generate specific outputs, such as predicting processor utilization, and initiating one or more actions, such as to facilitate cost effective or reduced cost processing, and thereby improve sustainability of the computing environment. Processing capabilities can be improved by using, for instance, communication networks to access one or more data sources, to obtain data that is then analyzed and used to make a prediction (e.g., predict processor utilization of a system) to facilitate generating a processor utilization simulation for the system to execute application code, and based on the processor utilization simulation for the system to execute the application code, to initiate an action, such as described herein.

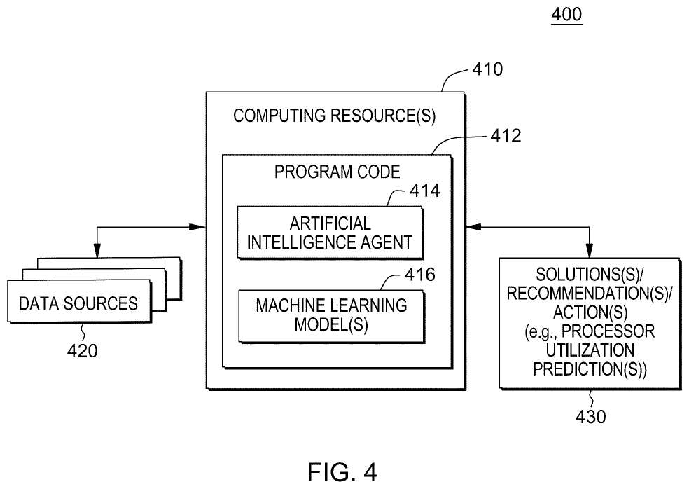

By way of further explanation, FIG. 4 depicts another embodiment of a computing environment or system 400, which can incorporate, or implement, one or more aspects of an embodiment of the present disclosure. In one or more implementations, system 400 is implemented as part of, or includes, a computing environment, such as computing environment 100 described above in connection with FIG. 1. System 400 includes one or more computing resources 410, such as one or more computers 101 of FIG. 1, that execute program code 412 that implements, for instance, one or more aspects of a module or facility such as disclosed herein, and which includes an artificial intelligence agent or system 414, which trains and (in one embodiment) utilizes one or more machine learning models 416, such as described herein. In one embodiment, data, such as system log data, code feature data, telemetry data, etc. for one or more systems, as described herein can be used by artificial intelligence agent 414, to train model(s) 416 to (for instance) predict processor utilization in executing application code on a system, and to facilitate generating a processor utilization simulation for the system to execute the application code, which can include, in one or more embodiments, a time series forecast of processor utilization and/or other related actions 430, etc., based on the particular application of the machine learning model(s) to facilitate achieving the processes disclosed. In implementation, system 400 can include, or utilize, one or more networks for interfacing various aspects of computing resource(s) 410, as well as one or more system data sources 420 providing data, and one or more components, systems, etc., receiving an output, action, etc., 430 of machine learning model(s) 416 to facilitate performance of one or more artificial intelligence agent operations. By way of example, the network(s) can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine learning model, and an output solution, recommendation, action, of the machine learning model(s), such as discussed herein.

In one or more implementations, computing resource(s) 410 house and/or execute program code 412 configured to perform computer-implemented methods in accordance with one or more aspects of the present disclosure. By way of example, computing resource(s) 410 can be a computing-system-implemented resource(s). Further, for illustrative purposes only, computing resource(s) 410 in FIG. 4 is depicted as being a single computing resource. This is a non-limiting example of an implementation. In one or more other embodiments, computing resource(s) 410, which implements one or more aspects of processing such as discussed herein, can, at least in part, be implemented in multiple separate computing resources or systems, such as one or more computing resources of a cloud-hosting environment, by way of example.

Briefly described, in one embodiment, computing resource(s) 410 can include one or more processor sets with one or more processors, for instance, central processing units (CPUs). Also, the processor set(s) can include functional components used in the integration of program code, such as functional components to fetch program code from locations in such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the artificial intelligence agent and machine learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s), or computing system(s) or competitor(s), which can implement one or more aspects disclosed are described further herein with reference to the figures.

As noted, in one embodiment, program code 412 includes, or executes, an artificial intelligence agent 414 which trains and uses one or more machine learning models 416. The models can be trained using training data that can include a variety of types of system data, such as disclosed herein. In one or more embodiments, program code 412 executing on one or more computing resources 410 applies one or more algorithms of, for instance, artificial intelligence agent 414 to generate and train the model(s), which the program code then utilizes to, for instance, predict processor utilization to execute application code, and/or to generate a processor utilization simulation for the system to execute the application code. In an initialization or learning stage, program code 412 trains the one or more machine learning models 416 using obtained training data that can include, in one or more embodiments, system log data, application code feature data, processor telemetry data, etc.

Data used to train the models (in one or more embodiments of the present disclosure) can include a variety of types of data, such as system data generated by one or more system data sources and/or system data stored in one or more databases accessible by, the computing resource(s). Program code, in embodiments of the present disclosure, can perform data analysis to generate data structures, including algorithms utilized by the program code to predict processor utilization and/or initiate (or perform) an action. As known, machine learning-based modeling solves problems that cannot be solved by numerical means alone. In one example, program code extracts features/attributes from the training data, which can be stored in memory or one or more databases. The extracted features can be utilized to develop a predictor function, h (x), also referred to as a hypothesis, which the program code utilizes as a model. In identifying machine learning model(s) 416, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weigh various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information, concepts/visual insights, tradeoff analytics, document conversion, and/or relationship extraction. In an embodiment, one or more programs analyze the data obtained by the program code from one or more sources utilizing one or more of a natural language classifier, retrieve-and-rank application programming interfaces, and tradeoff analytics application programing interfaces, etc.

In one or more embodiments, the program code can utilize one or more neural networks to analyze training data and/or collected data to generate an operational machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

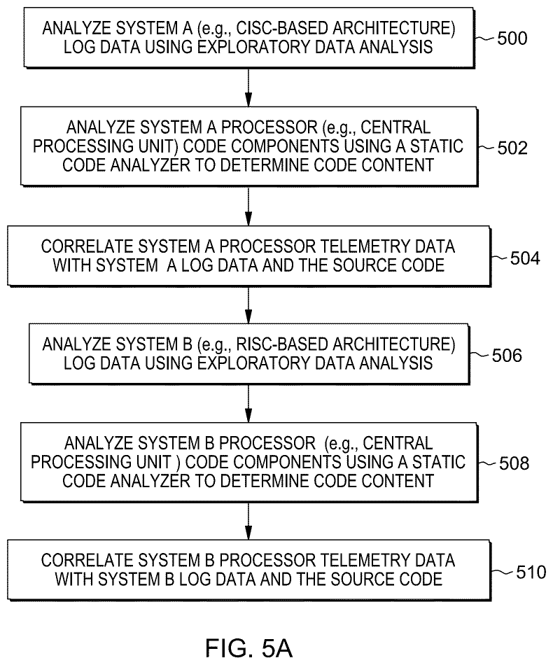

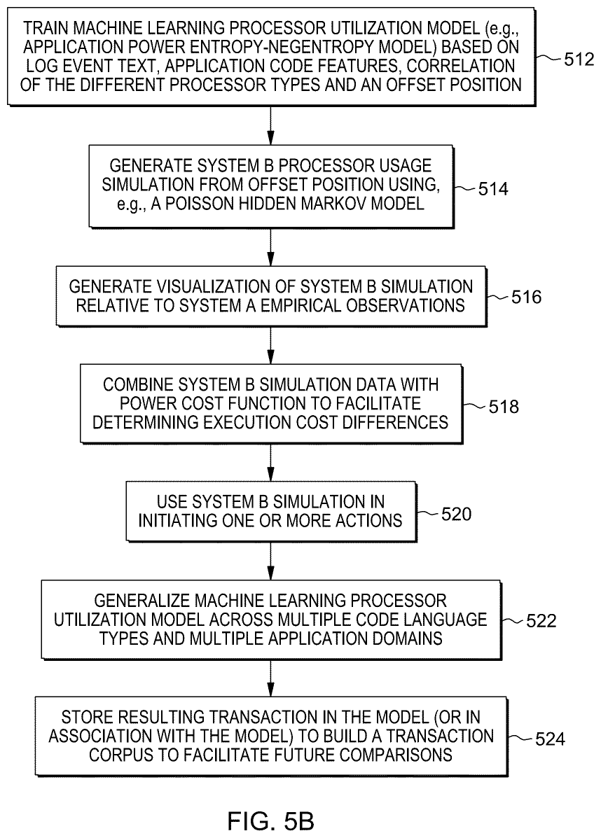

FIGS. 5A-5B depict a further embodiment of a processor utilization simulation process, in accordance with one or more aspects of present disclosure. In one or more aspects, this process facilitates determining power usage divergence between different systems in executing related code to accomplish the same or comparable work on the different systems, where the different systems have different processor type architectures. Initially, source code repositories for one system, system A (such as a CISC-based system), are analyzed, as well as the complied application's power consumption data for the system. For instance, in one or more embodiments, the process can include analyzing system A log data using exploratory data analysis 500, and analyzing system A processor (e.g., central processing unit) code components (e.g., compartments or blocks) using a static code analyzer to determine code content 502. The process can further include correlating system A processor telemetry data with system A log data and the source code executing, or to execute 504. In one or more embodiments, the processor telemetry data can include one or more logs, metrics, events, and/or traces created by code in execution. The process is then repeated for one or more systems, referred to as system B in one example. For instance, system B can be, or include a RISC-based architecture. The process includes analyzing system B log data using, for instance, exploratory data analysis 506, which in one or more embodiments, can include analyzing data sets and summarizing the data sets main characteristics. Further, the process includes, in one or more embodiments, analyzing system B processor code components using a static code analyzer to determine code content 508. Further, in one or more embodiments, the system B processor telemetry data is correlated with the system B log data and the source code executing, or to execute 510.

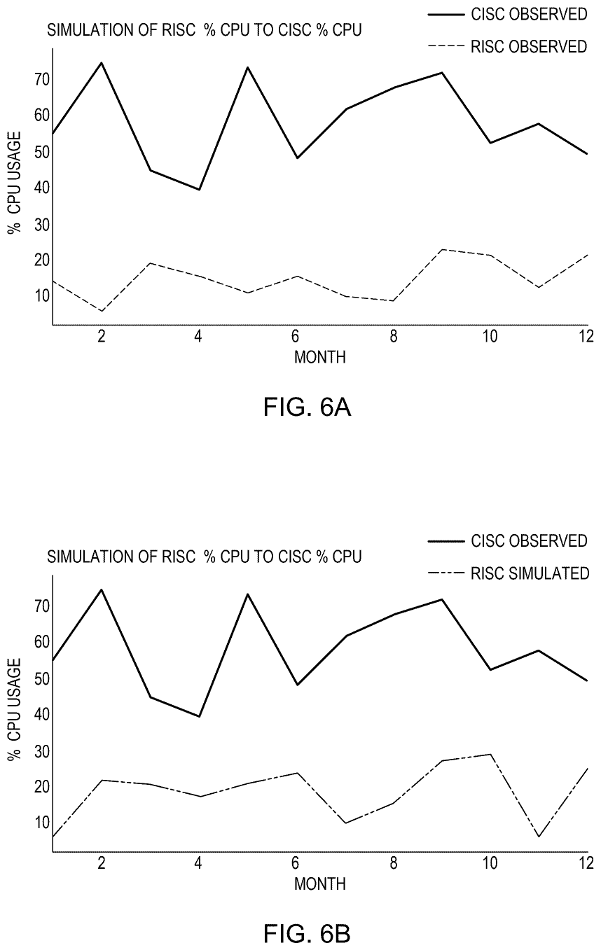

As illustrated in FIG. 5B, in one or more implementations, the process further includes training a machine learning processor utilization model (e.g., application power entropy-negentropy model) based on, for instance, the analyzed log event text, application code features, and correlation of the different processor types and an offset position between predictive processor utilization for executing related code to accomplish similar work on the different systems 512. Once the process utilization model is trained, it can be used to generate a processor utilization simulation, such as to generate a system B processor usage simulation, using the processor utilization model, from the offset position, and using a Poisson Hidden Markov model (in one embodiment) 514. Note that the system B processor usage simulation can be generated from, for instance, actual observed processor utilization data for system A to accomplish the same or similar work using the related code for system A, and/or a simulation of processor utilization for system A to execute the related code. In one or more embodiments, a visual representation, such as a graphical image, of the system B simulation relative to the system A simulation or empirical system A data 516 can be generated and displayed. An example of this is depicted in FIGS. 6A-6B. In FIG. 6A, CPU percent usage over a year of executing related code on one or more CISC-based systems is depicted in comparison to one or more RISC-based systems. In FIG. 6B, CPU percent usage over a year of executing related code on the CISC-based system(s) is depicted in comparison to predicted processor utilization of related code in a RISC-based system(s) to accomplish the same or similar work.

Continuing with FIG. 5B, in one or more embodiments, the process further includes combining system B simulation data with a power cost function to facilitate determining execution cost differences between, for instance, accomplishing comparable work on system A versus system B 518. In one or more implementations, the system B processor utilization simulation can be used to initiate one or more actions 520, such as described herein. In one or more implementations, the machine learning processor utilization model can also be generalized across multiple code language types, and multiple application domains 522. In one or more implementations, the resultant data from the process of FIGS. 5A-5B can be stored in the processor utilization model, or in association with the model, to build a transaction corpus to facilitate future comparisons of processor utilization between different systems executing similar or related code to accomplish the same or similar work.

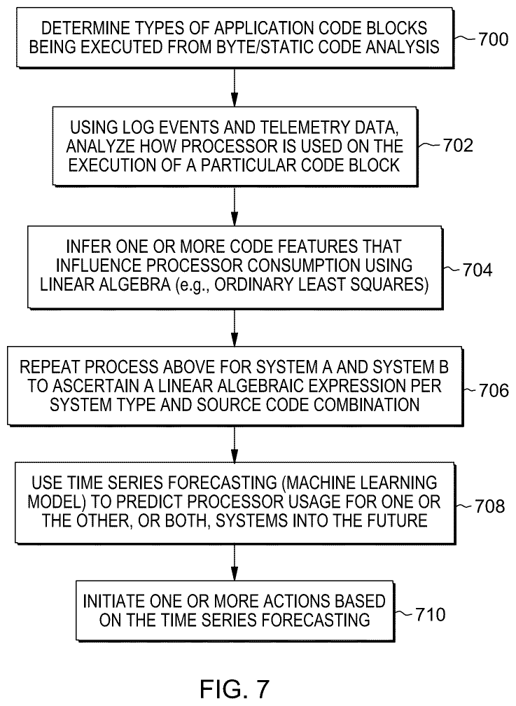

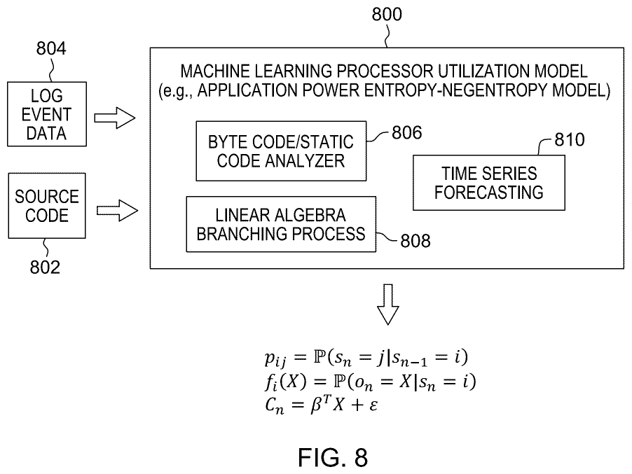

FIGS. 7-8 depict another example of a processor utilization simulation process and processor utilization model, in accordance with one or more aspects of present disclosure. As illustrated in FIG. 7, the process includes determining types of application code components or blocks being executed from, for instance, byte and/or static code analysis 700, an example of which is depicted in FIG. 8, where source code 802 is analyzed by a byte code/static code analyzer 806 associated with an artificial intelligence agent 800 to cross reference corresponding source code related to log event data branching results (in one embodiment). In one or more embodiments, artificial intelligence agent 800 includes a machine learning processor utilization model, such as an application power entropy-negentropy model, described herein.

As illustrated in FIG. 7, system log events and telemetry data can be used to observe how one or more processors are used in the execution of one or more code blocks or components (e.g., of an application code or source code) 802. As illustrated in FIG. 8, log event data and processor telemetry data 804 is also analyzed (in one or more embodiments) by artificial intelligence agent 800 to observe the extent of processor utilization with execution of one or more code components or blocks.

As illustrated in FIG. 7, in one or more embodiments, the artificial intelligence agent utilizes linear algebra processing 808 (FIG. 8) to infer one or more code features that influence processor consumption 704. Note that the linear algebra processing and/or branch processing allows for determination of one or more unique possibilities of dependent variables resulting from assigning independent variables based on values of the log event data. In one implementation, ordinary least squares processing can be used to infer processor consumption for a particular code feature (e.g., code component or block). In one or more implementations, processes 700-704 are repeated for one or more different systems to be compared, such as for a RISC-based system and a CISC-based system, to ascertain a linear algebraic expression for the system type and source code combination 706.

In one or more embodiments, time series forecasting (e.g., using the machine learning model) is used to predict processor usage for one system, and/or one or more other systems, into the future 708. Based on the time series forecasting 708 (e.g., times series forecasting 810 of machine learning processor utilization model 800 of FIG. 8), one or more actions can be initiated 710, such as one or more actions described herein. Those skilled in the art will note that the processor utilization model training and processor utilization simulation processes described herein are obtained using a unique processing combination of byte/static code analysis and linear algebra to provide, for instance, an application program entropy-negentropy model, where the model can infer, in one or more embodiments, savings in executing related code to accomplish the same or similar work in different systems with different processor architectures. In one or more implementations, the processes described can be applied to a series of applications, and the cumulative power difference in accomplishing the work on the different systems can be determined. For instance, processor usage (and/or power cost) can be determined for three different systems with different processor architectures, such as one system with a CISC-based processor architecture, another with a hybrid CISC-RISC-based processor architecture, and a further one with a RISC-based processor architecture.

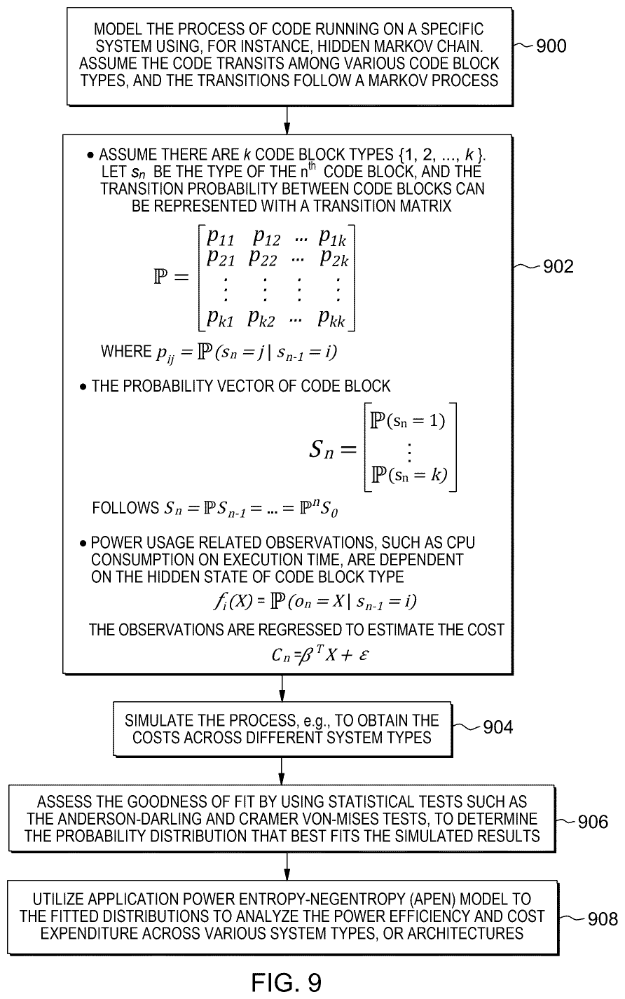

Further details of one embodiment of training a processor utilization model, in accordance with one or more aspects of present disclosure are illustrated in FIGS. 8-9. As illustrated in FIG. 9, in one or more embodiments, training and using the processor utilization model can include modeling the process of code running on a specific system, for instance, using a Hidden Markov chain, with the assumption that the application code transits among various code block types, and the transitions follow a Markov process 900. Further, in one or more embodiments, there is an assumption that there are k code block types [1, 2 . . . k]. Letting Sn be the type of the n^{th} code block, that the transition probability pᵢⱼ between different code blocks can be represented with a transition matrix 902. As illustrated, power usage related data, such as processor consumption at execution time, is dependent on the hidden state of the code block type. Further, the determined data can be regressed to estimate the processor utilization cost, as illustrated.

Note that with reference to block 902, P refers to the overall probabilistic state changes within a two-time series data embodiment (e.g., for a CISC-based system and RISC-based system). For example, for a CISC-based processor system, the respective time series line can move up, down or stay the same through each successive point measured. Similarly, for a RISC-based processor system, the time series will have the same three states. In total there can be 9 possible states in one example, such that the probabilities of each will be P11 P12 P13 (first row) to P31 P32 P33 (last row), with the middle row being P21 P22 P23.

The probability vector of a code block is the likelihood of a particular code block appearing in an overall class function, so this information is captured in a separate vector P(Sn=1), which references the probability of a first block of code being of a particular type.

The third formula fᵢ (x)= [symbol] (oₙ=X|sₙ₋₁=i) is the conditional probability of a value from the first transition matrix given the probability from the second probability vector to determine the probability of a state change given a distinct code block being exercised. The final formula in block 902 is a linear regression cost function where C is the overall cost with Beta being a weight value and x being the simulated processor (e.g., CPU) value and epsilon being an error or slope/intercept value.

One or more processor utilization simulations can be generated to, for instance, anticipate execution costs of one or more application programs across different system types 904, with the goodness of the fit of the simulation to be assessed using statistical tests, such as the Anderson-Darling and Cramer Von-Mises tests, to determine a probability distribution that best fits the simulated results 906. The resultant application power entropy-negentropy model to the fitted distributions can be used to analyze, for instance, power efficiency and/or cost expenditure across various system types with different processor architecture in executing the application program(s) (or codes) 908.

Those skilled in the art will note from the above-description that provided herein are computer-implemented methods, computer program products, and computer systems for facilitating processing within a computing environment, and more particularly, for simulating processor utilization for a system in executing application code. In one or more embodiments, the process includes training a processor utilization model using system log data, code feature data, and processor-associated data of a system to, at least in part, predict processor utilization to execute application code on the system, where the processor utilization model is a machine learning processor utilization model. Further, in one or more embodiments, the process includes generating, using the processor utilization model, a processor utilization simulation for the system to execute the application code, and initiating an action based on the processor utilization simulation for the system to execute the application code.

In embodiments, the training further includes training the processor utilization model for another system using system log data, code feature data and processor-associated data of the other system to facilitate predicting the processor utilization to execute the application code on the system based, at least in part, on an execution of related code on the other system, where the system and the other system are different systems with different processor architectures, and the application code and the related code are to accomplish comparable work, such as at least in part, the same work, on the different systems.

In one or more embodiments, training the processor utilization model includes building an application power entropy-negentropy model structure based on the respective system log data, the respective code feature data, and a correlation of one or more execution-related differences between the system and the other system, as well as an offset position between the system execution of the application code, and the other system execution of the related code.

In one or more embodiments, the system is a reduced instruction set architecture (RISC)-based system and the other system is a complex instruction set architecture (CISC)-based system. Further, in one or more embodiments, the process can include generating a graphical representation of the processor utilization simulation for the RISC-based system to execute the application code relative to empirical data of processor utilization during execution of the related code on the CISC-based system.

In one or more embodiments, training the processor utilization model for the system includes analyzing the system log data using exploratory data analysis, and analyzing the code feature data using a static code analyzer to determine code content. Further, the process can include, based on the analyzing of the system log data and the analyzing of the code feature data, correlating processor telemetry data with the system log data, and execution of code to infer, using linear algebra, one or more code features of the application code that influence system processor utilization.

In one or more embodiments, the training includes training the processor utilization model for another system, where the system and the other system are different systems based on different processor architectures. The training for the other system includes analyzing other system log data using exploratory data analysis, and analyzing other system code feature data using the static code analyzer to determine code content. Further, the process includes, based on the analyzing of the other system log data and the analyzing of the other system code feature data, correlating, for the other system, processor telemetry data with the other system log data, and execution of related code on the other system to infer, using linear algebra, one or more code features of the related code that influence other system processor utilization, where the application code and the related code are to accomplish, at least in part, the same or similar work on the different systems.

In one or more embodiments, the process further includes predicting for a time period, based at least in part on the processor utilization simulation, a difference in processor utilization in executing the application code on the RISC-based system in comparison to executing the related code on the CISC-based system.

In another embodiment, systems and computer-implemented processes are provided for simulating and determining power usage divergence in a data center between different processor-based systems. The process includes, in one or more embodiments, analyzing source code for a CISC-based computer system and the system's complied power consumption data. In addition, the process includes analyzing source code for, for instance, a RISC-based computer system and its complied power consumption data. Further, the process includes generating a power entropy-negentropy model based on the analysis of the source code for the CISC-based computer system(s) and the RISC-based computer system(s), where the model uses, in one or more embodiments, a linear algebraic expression for each of the CISC and RISC-based computer systems and their respective source codes. Using time series forecasting, the process includes determining processor utilization and/or processor costs in executing or running comparable applications on the different CISC-based computer systems and the RISC-based computer systems.

The computing environments described herein are only examples of computing environments that can be used. One or more aspects of the present disclosure may be used with many types of environments. The computing environments provided herein are only examples. Each computing environment is capable of being configured to include one or more aspects of the present disclosure.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other memory access instructions may be used. Further, other predictors may be used, including, but not limited to, other examples of a counter table and/or a global counter. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
training a processor utilization model using system log data, code feature data, and processor-associated data of a system to, at least in part, predict processor utilization to execute application code on the system, the processor utilization model being a machine learning processor utilization model;
generating, using the processor utilization model, a processor utilization simulation for the system to execute the application code; and
initiating an action based on the processor utilization simulation for the system to execute the application code.

2. The computer-implemented method of claim 1, wherein the training further comprises training the processor utilization model for another system using system log data, code feature data and processor-associated data of the other system to facilitate predicting the processor utilization to execute the application code on the system based, at least in part, on an execution of related code on the other system, wherein the system and the other system are different systems with different processor architectures, and the application code and the related code are to accomplish, at least in part, comparable work on the different systems.

3. The computer-implemented method of claim 2, wherein training the processor utilization model includes building an application power entropy-negentropy model structure based on the respective system log data, the respective code feature data, and a correlation of one or more execution-related differences between the system and the other system, as well as an offset position between the system execution of the application code, and the other system execution of the related code.

4. The computer-implemented method of claim 2, where the system is a reduced instruction set computer (RISC)-based system and the other system is a complex instruction set computer (CISC)-based system.

5. The computer-implemented method of claim 4, further comprising generating a graphical representation of the processor utilization simulation for the RISC-based system to execute the application code relative to empirical data related to processor utilization during execution of the related code on the CISC-based system.

6. The computer-implemented method of claim 1, wherein training the processor utilization model for the system includes:
analyzing the system log data using exploratory data analysis;
analyzing the code feature data using a static code analyzer to determine code content; and
based on the analyzing of the system log data and the analyzing of the code feature data, correlating processor telemetry data with the system log data, and execution of code to infer, using linear algebra, one or more code features of the application code that influence system processor utilization.

7. The computer-implemented method of claim 6, wherein the system and another system are different systems based on different processor architectures, and wherein training the processor utilization model further includes for the other system:
analyzing other system log data using exploratory data analysis;
analyzing other system code feature data using the static code analyzer to determine code content; and
based on the analyzing of the other system log data and the analyzing of the other system code feature data, correlating, for the other system, processor telemetry data with the other system log data, and execution of related code on the other system to infer, using linear algebra, one or more code features of the related code that influence other system processor utilization, where the application code and the related code are to accomplish, at least in part, comparable work on the different systems.

8. The computer-implemented method of claim 7, where the system is a reduced instruction set computer (RISC)-based system and the other system is a complex instruction set computer (CISC)-based system.

9. The computer-implemented method of claim 8, further comprising predicting for a time period, based at least in part on the processor utilization simulation, a difference in processor utilization in executing the application code on the RISC-based system in comparison to executing the related code on the CISC-based system.

10. A computer program product for facilitating processing within a computer environment, the computer program product comprising:
a set of one or more computer readable storage media; and
program instructions, collectively stored in the set of one or more computer readable storage media, for causing at least one processor set to perform computer operations comprising:
training a processor utilization model using system log data, code feature data, and processor-associated data of a system to, at least in part, predict processor utilization to execute application code on the system, the processor utilization model being a machine learning processor utilization model;
generating, using the processor utilization model, a processor utilization simulation for the system to execute the application code; and
initiating an action based on the processor utilization simulation for the system to execute the application code.

11. The computer program product of claim 10, wherein the training further comprises training the processor utilization model for another system using system log data, code feature data and processor-associated data of the other system to facilitate predicting the processor utilization to execute the application code on the system based, at least in part, on an execution of related code on the other system, wherein the system and the other system are different systems with different processor architectures, and the application code and the related code are to accomplish, at least in part, comparable work on the different systems.

12. The computer program product of claim 11, wherein training the processor utilization model includes building an application power entropy-negentropy model structure based on the respective system log data, the respective code feature data, and a correlation of one or more execution-related differences between the system and the other system, as well as an offset position between the system execution of the application code, and the other system execution of the related code.

13. The computer program product of claim 10, wherein training the processor utilization model for the system includes:
analyzing the system log data using exploratory data analysis;
analyzing the code feature data using a static code analyzer to determine code content; and
based on the analyzing of the system log data and the analyzing of the code feature data, correlating processor telemetry data with the system log data, and execution of code to infer, using linear algebra, one or more code features of the application code that influence system processor utilization.

14. The computer program product of claim 13, wherein the system and another system are different systems based on different processor architectures, and wherein training the processor utilization model further includes for the other system:
analyzing other system log data using exploratory data analysis;
analyzing other system code feature data using the static code analyzer to determine code content; and
based on the analyzing of the other system log data and the analyzing of the other system code feature data, correlating, for the other system, processor telemetry data with the other system log data, and execution of related code on the other system to infer, using linear algebra, one or more code features of the related code that influence other system processor utilization, where the application code and the related code are to accomplish, at least in part, comparable work on the different systems.

15. The computer program product of claim 14, where the system is a reduced instruction set computer (RISC)-based system and the other system is a complex instruction set computer (CISC)-based system.

16. The computer program product of claim 15, further comprising predicting for a time period, based at least in part on the processor utilization simulation, a difference in processor utilization in executing the application code on the RISC-based system in comparison to executing the related code on the CISC-based system.

17. A computer system for facilitating processing within a computing environment, the computer system comprising:
at least one processor set;
a set of one or more computer readable storage media; and
program instructions, collectively stored in the set of one or more computer readable storage media, for causing the at least one processor set to perform computer operations comprising:
training a processor utilization model using system log data, code feature data, and processor-associated data of a system to, at least in part, predict processor utilization to execute application code on the system, the processor utilization model being a machine learning processor utilization model;
generating, using the processor utilization model, a processor utilization simulation for the system to execute the application code; and
initiating an action based on the processor utilization simulation for the system to execute the application code.

18. The computer system of claim 17, wherein the training further comprises training the processor utilization model for another system using system log data, code feature data and processor-associated data of the other system to facilitate predicting the processor utilization to execute the application code on the system based, at least in part, on an execution of related code on the other system, wherein the system and the other system are different systems with different processor architectures, and the application code and the related code are to accomplish, at least in part, comparable work on the different systems.

19. The computer system of claim 18, wherein training the processor utilization model includes building an application power entropy-negentropy model structure based on the respective system log data, the respective code feature data, and a correlation of one or more execution-related differences between the system and the other system, as well as an offset position between the system execution of the application code, and the other system execution of the related code.

20. The computer system of claim 19, where the system is a reduced instruction set computer (RISC)-based system and the other system is a complex instruction set computer (CISC)-based system.
